(19) United States
(12) Patent Application Publication
(10) Pub. No.: US 2012/0136961 A1
(43) Pub. Date: May 31, 2012

(54) SYSTEM, SERVER AND METHOD FOR ADMINISTRATING REMOTE DEVICE

(75) Inventors: Yuan-Ching Chen, Kaohsiung County (TW); Hung-Lieh Hu, Hsinchu City (TW); Hsueh-Chih Chang, Changhua County (TW)

(73) Assignee: INDUSTRIAL TECHNOLOGY RESEARCH INSTITUTE, Hsinchu (TW)

(21) Appl. No.: 13/018,359

(22) Filed: Jan. 31, 2011

(30) Foreign Application Priority Data
Nov. 29, 2010 (TW) 99141262

(51) Int. Cl. G06F 15/16; H05B 37/00; G06F 9/46

(52) U.S. Cl. 709/217; 719/328; 315/129

(57) ABSTRACT

A system, a server, and a method for administrating a remote device are provided. The system includes a target device and a server. The server is coupled to the target device. The server includes a database and an event notice interface. A command content of a remote device administration command to be transmitted to the target device is recorded into the database, and a command number of the remote device administration command is recorded into the event notice interface. The server checks the event notice interface and sends the command content from the database to the target device according to the event notice interface.

### CROSS-REFERENCE TO RELATED APPLICATION

This application claims the priority benefit of Taiwan application serial no. 99141262, filed on Nov. 29, 2010. The entirety of the above-mentioned patent application is hereby incorporated by reference herein and made a part of this specification.

### TECHNICAL FIELD

The disclosure relates to administration of a remote device, and more particularly, to a system, a server, and a method for administrating a remote device.

### BACKGROUND

In a conventional light emitting diode (LED) street light administration system, a server needs to collect device information from a large number of street lights and receive administration instructions from administrators, technicians, and application programs. Besides, the server needs to respond to different information received from remote street lights and process administration instructions issued by local or remote administrators, technicians, and application programs in real time.

### SUMMARY

The disclosure is directed to a system, a server, and a method for administrating a remote device, wherein the frequency of database polling or database accessing is greatly reduced and accordingly the efficiency of the server is improved.

According to an embodiment of the disclosure, a remote device administration system including a target device and a server is provided. The server is coupled to the target device. The server includes a database and a first event notice interface. A command content of a remote device administration command is recorded in the database, and a command number of the remote device administration command is recorded in the first event notice interface. The server sends the command content from the database to the target device according to the command number in the first event notice interface.

According to another embodiment of the disclosure, a remote device administration server including an application unit, a database, a first event notice interface, and a protocol parser is provided. The database and the first event notice interface are coupled to the application unit. The application unit records a command content of a remote device administration command into the database and records a command number of the remote device administration command into the first event notice interface. The protocol parser is coupled to the database and the first event notice interface. The protocol parser reads the command content of the remote device administration command from the database according to the command number of the first event notice interface and compiles the command content of the remote device administration command.

According to another embodiment of the disclosure, a remote device administration method including following steps is provided. A server having a database and a first event notice interface is provided. A command content of a remote device administration command is recorded into the database, and a command number of the remote device administration command is recorded into the first event notice interface. The first event notice interface is checked, and the command content is sent from the database to a remote target device according to the command number of the first event notice interface.

According to another embodiment of the disclosure, a remote parking lot administration system including a user interface is provided. The user interface further includes a parent layer and a child layer. The parent layer has at least one web map, wherein the web map contains the marker of at least one parking lot. The child layer has at least one parking field sitemap, wherein the parking field sitemap contains the marker of at least one target device. When the marker of the parking lot is selected, the parent layer displays a general information of the child layer to activate the child layer and display the parking field sitemap.

As described above, in an embodiment of the disclosure, a command number of a remote device administration command is recorded in an event notice interface. Compared to a command content of the remote device administration command, the command number of the remote device administration command has a much smaller data quantity. A server can get to know whether the command content is recorded in a database by checking the event notice interface. Thereby, the system, server, and method for administrating a remote device disclosed in the present embodiment can considerably reduce the frequency of database polling, database checking, or database accessing and improve the efficiency of the server.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A is a block diagram of a remote device administration system.

FIG. 1B is a block diagram of a remote device administration system according to an embodiment of the disclosure.

FIG. 2 is a diagram illustrating how an application unit writes a remote device administration command according to an embodiment of the disclosure.

FIG. 3 is a diagram illustrating a command reading and transmitting procedure of a protocol parser according to an embodiment of the disclosure.

FIG. 4 is a diagram illustrating a device status event writing procedure of a protocol parser according to an embodiment of the disclosure.

FIG. 5 is a diagram illustrating an emergency event reading procedure of an application unit according to an embodiment of the disclosure.

FIG. 6 is a diagram of a remote device administration system applied to street light administration according to an embodiment of the disclosure.

FIG. 7 is a diagram of a target device applied to street light administration according to an embodiment of the disclosure.

FIG. 8 is a diagram illustrating how a graphic information maintenance module operates in 3-dimensional (3D) space according to an embodiment of the disclosure.

FIG. 9 is a diagram illustrating functional modules of an application unit according to an embodiment of the disclosure.

### DETAILED DESCRIPTION OF DISCLOSED EMBODIMENTS

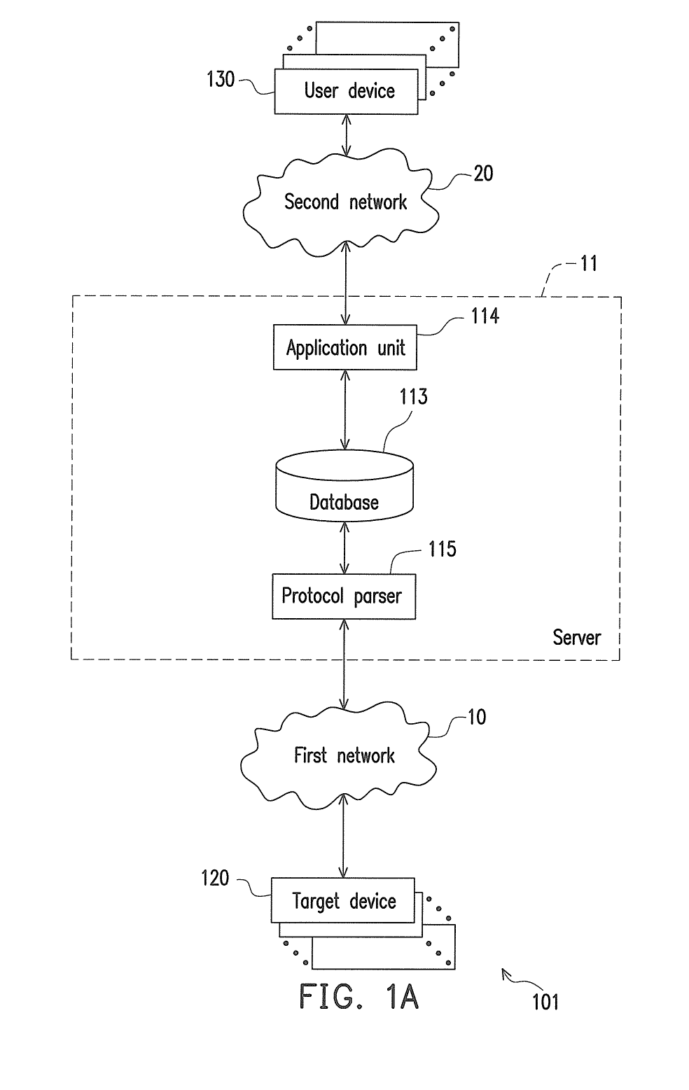

FIG. 1A is a block diagram of a remote device administration system 101. The remote device administration system 101 includes a server 11, a target device 120, and a user device 130. The target device 120 is coupled to the server 11. The target device 120 sends a device status event to the server 11 and receives a remote device administration command from the server 11 through a first network 10. The target device 120 may be a street light, a parking lot/garage administration device, an indoor illumination device, a surveillance device, an automated (unmanned) factor, and/or other devices to be remotely controlled. Based on the monitored property of the target device 120, the device information of the device status event may contain electrical properties (for example, current, voltage, and power), physical properties (for example, temperature and brightness), and/or other properties (for example, operating status, monitoring image, failure alarm, and number of vehicles) of the target device 120. In addition, the first network 10 may be the Internet, a local network, a wireless network, an asymmetric digital subscriber line (ADSL), a telecommunication network, a fiber to the x (FTTx) network, or any other communication network.

The user device 130 is coupled to the server 11. The user device 130 can send a remote device administration command to the server 11 and receive the device status event of the target device 120 from the server 11 through a second network 20. The second network 20 and the first network 10 may be the same network or different networks based on the requirement of the application environment. The user device 130 includes an operation platform for administrators, technicians, citizens, and/or other users, wherein the operation platform may be a personal computer (PC), a notebook computer, a smart phone, and a personal digital assistant (PDA), etc.

When a remote device administration command is about to be sent to the target device 120, the application unit 114 records the remote device administration command into the database 113. The occurrence time and command content of the remote device administration command are unpredictable. In order to process the remote device administration command in real time, a protocol parser 115 periodically and frequently polls or accesses the database 113. However, the protocol parser 115 repeatedly and frequently polling the database 113 makes the database 113 heavy laden and may even impair the execution efficiency of the remote device administration system 101.

FIG. 1B is a block diagram of a remote device administration system 100 according to an embodiment of the disclosure. The remote device administration system 100 includes a server 110, a target device 120, and a user device 130. The target device 120 and the user device 130 are coupled to the server 110. The embodiment illustrated in FIG. 1B can be referred to the description of the remote device administration system 101 illustrated in FIG. 1A. However, unlike that in the remote device administration system 101, the server 110 in the remote device administration system 100 includes a database 113 and at least one event notice interface. In the present embodiment, the server 110 includes a first event notice interface 111 and a second event notice interface 112. The first event notice interface 111 and the second event notice interface 112 may be implemented through any technique. For example, the first event notice interface 111 and the second event notice interface 112 may be implemented as flags, environment variables, mail pool, message queues, semaphores, shared memory, inter-process communication (IPC), inter-process messaging, or any other memory access technique which allows communication between different application programs or processes. A messaging function is used for transmitting messages to other processes and receiving messages from other processes. Or, the first event notice interface 111 and/or the second event notice interface 112 may also be implemented through a non-shared memory TCP/UDP technique, wherein TCP refers to the transmission control protocol, and UDP refers to the user datagram protocol.

Additionally, the server 110 further includes an application unit 114 and a protocol parser 115. The application unit 114 may trigger a corresponding remote device administration command and send the remote device administration command to the target device 120 in response to an administration requirement of the target device 120. Or, the application unit 114 may send a remote device administration command issued by the user device 130 to the target device 120. Taking an application in an illumination control system as an example, the remote device administration command contains a turn-on command, a turn-off command, or a status inquiry command (for example, for inquiring the operation status or power consumption status of the illumination device) issued to a remote illumination device.

When a remote device administration command is to be transmitted to the target device 120, the application unit 114 records the command content of the remote device administration command into the database 113 and records the command number of the remote device administration command into the first event notice interface 111. The occurrence time and the command content of the remote device administration command are unpredictable. In order to process the remote device administration command in real time, in the present embodiment, the protocol parser 115 of the server 110 polls or checks the first event notice interface 111 to considerably reduce the frequency of polling, checking or accessing the database 113. Compared to the command content recorded in the database 113, the command number recorded in the first event notice interface 111 has much smaller data quantity (or bit number). Thus, frequent polling or checking the database 113 can be avoided by polling or checking the first event notice interface 111, and accordingly the efficiency of the server 110 can be improved.

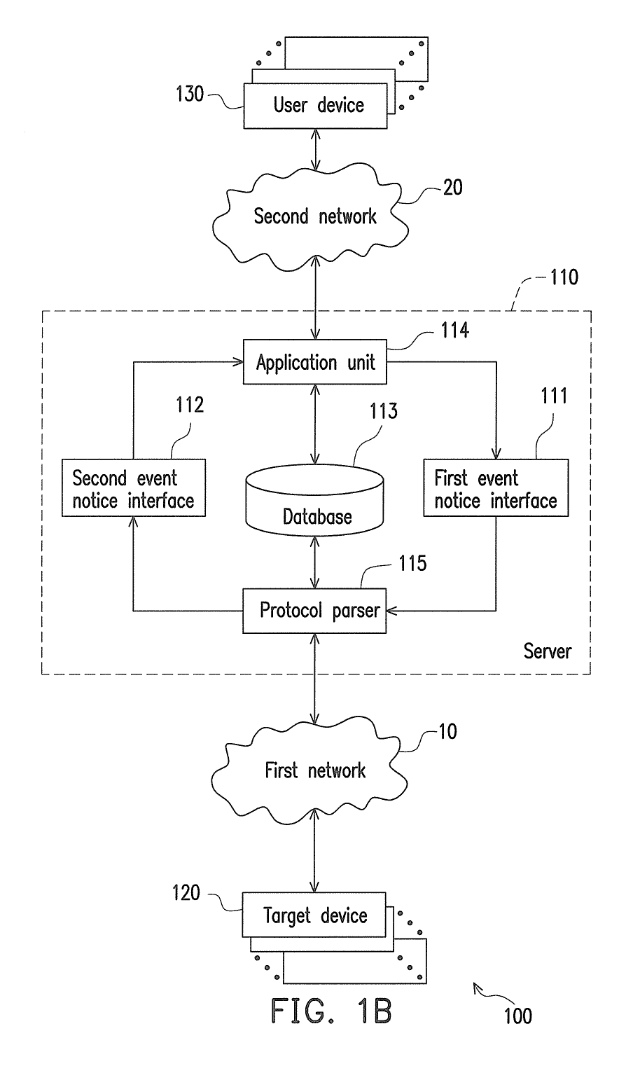

FIG. 2 is a diagram illustrating how the application unit 114 writes a remote device administration command according to an embodiment of the disclosure. Referring to FIG. 1B and FIG. 2, when the application unit 114 receives a remote device administration command from the user device 130, the application unit 114 writes the content of the remote device administration command into the database 113 (step S210) and records the command number of the remote device administration command into the first event notice interface 111 (for example, by adding 1 to the command number of the remote device administration command in the first event notice interface 111) (step S220).

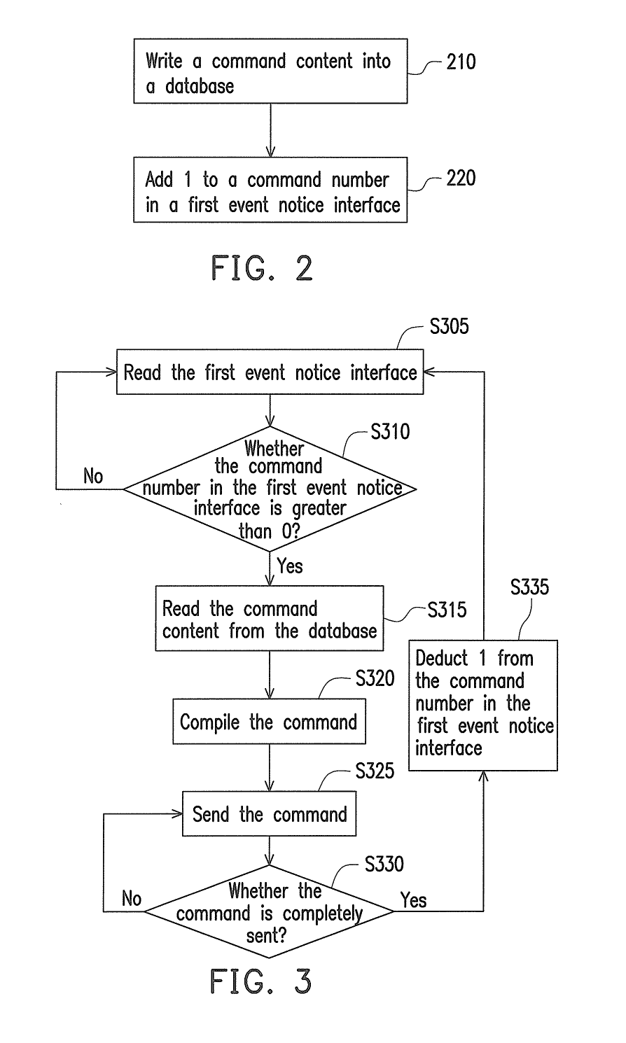

FIG. 3 is a diagram illustrating a command reading and transmitting procedure of the protocol parser 115 according to an embodiment of the disclosure. Referring to FIG. 1B and FIG. 3, the protocol parser 115 reads the first event notice interface 111 (step S305) and determines whether there is unsent remote device administration command in the database 113 according to the first event notice interface 111 (for example, by determining whether the command number of the remote device administration command in the first event notice interface 111 is greater than 0) (step S310). If the command number of the remote device administration command is not greater than 0, step S305 is executed again. Because the protocol parser 115 constantly monitors/polls the first event notice interface 111, the protocol parser 115 can instantly detect whether there is any remote device administration command to be processed in the database 113. If the first event notice interface 111 indicates that there is a remote device administration command to be processed in the database 113 (i.e., the command number of the remote device administration command is greater than 0), the protocol parser 115 captures the content of the remote device administration command from the database 113 (step S315) and compiles it (step S320). After that, the protocol parser 115 sends the compiled remote device administration command to the target device 120 through a socket and the first network 10 (step S325). Then, whether the remote device administration command is completely transmitted is determined (step S330). After the remote device administration command is completely transmitted, the command number of the remote device administration command recorded in the first event notice interface 111 is correspondingly adjusted (for example, by deducting 1 from the command number of the remote device administration command) (step S335). After that, step S305 is executed again. Namely, the protocol parser 115 compiles the corresponding command content in the database 113 according to the first event notice interface 111 and sends the compiled command content to the target device 120.

In addition, the protocol parser 115 can send a device status event issued by the target device 120 to the user device 130. Taking an application in an illumination control system as an example, the remote target device 120 may contain a plurality of illumination devices and related control circuits, and the device information of the device status event may be a general event (for example, the operation status or power consumption status of the illumination devices) or an emergency event (for example, a failure alarm of the illumination devices or a power supply system). The occurrence time of the device status event is unpredictable.

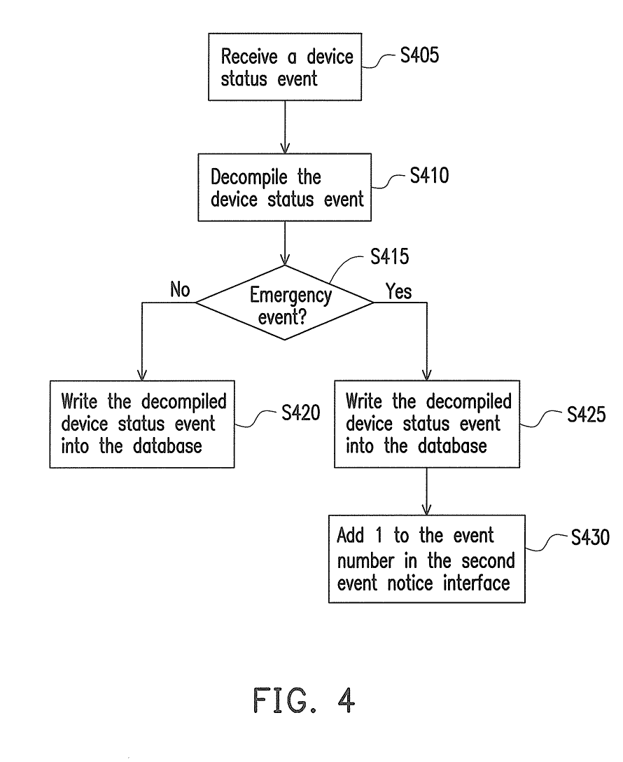

FIG. 4 is a diagram illustrating a device status event writing procedure of the protocol parser 115 according to an embodiment of the disclosure. Referring to FIG. 1B and FIG. 4, when the protocol parser 115 receives a device status event issued by the target device 120 through a socket and the first network 10 (step S405), the protocol parser 115 deparses/decompiles the device status event according to a protocol (step S410). Next, the protocol parser 115 determines whether the device status event issued by the target device 120 is an emergency event (step S415). If the device status event issued by target device 120 is a general event, the protocol parser 115 records the device information of the decompiled device status event into the database 113 (step S420). Thus, the application unit 114 can access the database 113 according to the requirement of the user device 130 and send the latest device information of the target device 120 to the user device 130 at a predetermined time.

If the device status event issued by the target device 120 is an emergency event, the protocol parser 115 records the device information of the device status event into the database 113 (step S425) and records a device information number of the device status event into a corresponding flag, environment variable, or mail pool of the second event notice interface 112 (step S430). Herein the flag, environment variable, or mail pool indicates the number of unread/unprocessed device status events (emergency events) in the database 113

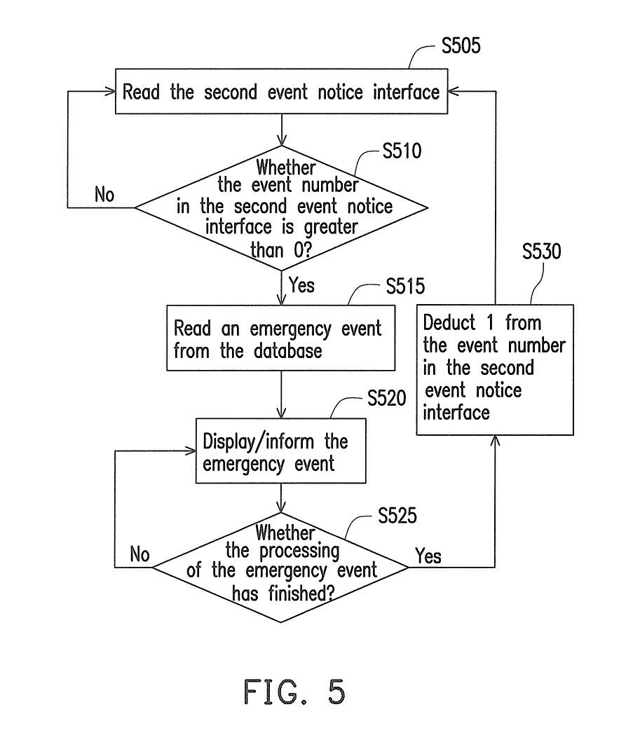

FIG. 5 is a diagram illustrating an emergency event reading procedure of the application unit 114 according to an embodiment of the disclosure. Referring to FIG. 1B and FIG. 5, the application unit 114 reads the second event notice interface 112 (step S505) and determines whether there is any unprocessed emergency event in the database 113 according to the device information number of the second event notice interface 112 (for example, by determining whether the device information number of the emergency event in the second event notice interface 112 is greater than 0) (step S510). If the device information number of the emergency event is not greater than 0, step S505 is executed again. Because the application unit 114 constantly monitors/polls the second event notice interface 112, the application unit 114 can instantly detect whether there is any emergent device status event to be processed in the database 113. Namely, the application unit 114 reads the corresponding device information from the database 113 according to the second event notice interface 112. If the second event notice interface 112 indicates that there is an emergent device status event to be processed in the database 113 (i.e., the device information number of the emergency event is greater than 0), the application unit 114 needs not to wait until a predetermined time to process the emergency event. Instead, the application unit 114 instantly captures the content of the device status event from the database 113 and deparses it (step S515).

Thereafter, the application unit 114 processes the emergency event (step S520). For example, the application unit 114 displays the emergency event and/or notifies the remote user device 130 about the emergency event through an Internet information server (IIS) or an Apache server. The application unit 114 may also notify related modules about this emergency event. Taking an application in an illumination control system as an example, the application unit 114 may notify a street light event inquiry module about the emergency event. Then, whether the processing of the emergency event is completed is determined (step S525). After the processing of the emergency event is completed, the device information number of the emergency event recorded in the second event notice interface 112 is adjusted correspondingly (for example, by deducting 1 from the device information number of the emergency event) (step S530). After that, step S505 is executed again.

According to the present embodiment, the application unit 114 and the protocol parser 115 do not constantly poll the database 113 during a short time or increase the load on the database 113, so that the execution efficiency of the remote device administration system 100 is not affected. When the application unit 114 receives a remote device administration command from the user device 130, since the remote device administration command is not related to the lower layer protocol, the application unit 114 directly writes the remote device administration command into the database 113. Because the application unit 114 and the protocol parser 115 are separated by the database 113, when the protocol of the application unit 114 or the protocol parser 115 needs to be extended or updated, the portion of the application unit 114 or the protocol parser 115 alone needs to be updated. Thus, system maintenance and migration are made very convenient. Moreover, the frequency of accessing the database 113 is greatly reduced through cross-process variables or techniques, such as the event notice interfaces 111 and 112. Spare time of the database 113 can be used for processing other requirements of the system, so that the execution time of the system can be shortened and the execution efficiency thereof can be improved.

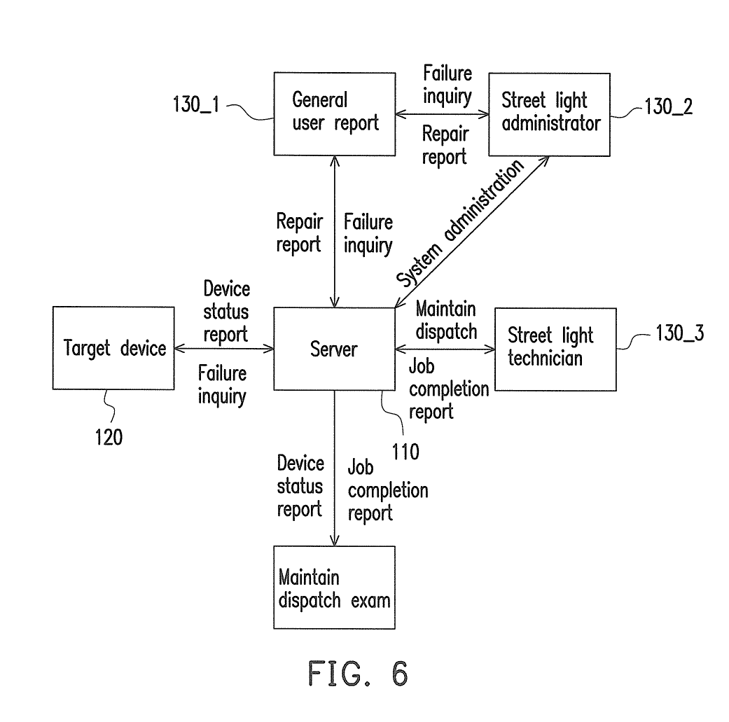

FIG. 6 is a diagram of the remote device administration system 100 applied to street light administration according to an embodiment of the disclosure. Implementation details of the present embodiment can be referred to the descriptions related to FIGS. 1B-5. The target device 120 includes remote street lights and related facilities, and the user device 130 includes a device 130_1 used by general users, a device 130_2 used by street light administrators, and a device 1303 used by street light technicians.

Referring to FIG. 1B and FIG. 6, first, the protocol parser 115 decompiles an emergency event (for example, a failure event) received from a sensor in the remote target device 120 and writes the decompiled emergency event into the database 113. After that, a street light event inquiry module of the application unit 114 frequently polls the second event notice interface 112 and reads the emergency event from the database 113 according to the device information number of the second event notice interface 112. Or, the protocol parser 115 decompiles a general even received from a sensor of a remote target device 120 and writes the decompiled general event into the database 113. After that, the street light event inquiry module of the application unit 114 polls the database 113 at intervals to read the device information (for example, the voltage or current on the street lights) and analyzes the device information to determine whether the remote target device 120 fails (for example, by determining whether the voltage or current conforms to an error rule).

When the street light event inquiry module of the application unit 114 detects a failure event in the remote target device 120, the street light event inquiry module notifies a failure report and repair module of the application unit 114. The failure report and repair module captures the serial number and error information of the failed device and stores the captured information into the database 113. After that, the failure report and repair module sends the serial number and the error information to a dispatch and maintenance module of the application unit 114. The dispatch and maintenance module converts the serial number into a position of the device and determines which kind of repair material is used according to the error information.

After that, the dispatch and maintenance module notifies the device 130_3 used by street light technicians about repair information (i.e., the position, serial number, cause of failure, and number of repair materials, etc) of the failed device. When a street light technician receives the repair information and finishes repairing the remote target device 120, the street light technician inputs the repair result information into the dispatch and maintenance module by using the device 130_3. The dispatch and maintenance module calculates the numbers of the repair materials used by the street light technician and the remnants and sends a job completion report information to the failure report and repair module. The failure report and repair module then determines whether the remote target device 120 works properly by inquiring the street light event inquiry module. If the street light technician has actually repaired the remote target device 120, the status of the target device 120 obtained by the street light event inquiry module should be normal. If the target device 120 is normal, the error information previously recorded in the database 113 is removed. If the target device 120 is still abnormal, the dispatch and maintenance module is notified again to perform forgoing process again until the target device 120 is repaired or foregoing process has been performed for a predetermined number of times.

When a general user detects a failure of the remote target device 120, the general user can visit a failure report webpage on the Internet by using a computer (i.e., the device 130_1), and the general user can select on an icon corresponding to the failed device and select a failure status in the failure report webpage. The failure report and repair module captures the serial number and the error information of the failed device and stores the same into the database 113. After that, the failure report and repair module sends the serial number and the error information to the dispatch and maintenance module. The dispatch and maintenance module converts the serial number into a position of the device and determines which kind of repair material is used according to the error information. After that, the dispatch and maintenance module notifies the device 130_3 used by the street light technician about repair information (i.e., position, serial number, cause of failure, and number of repair materials) of the failed device. When the street light technician receives the repair information and finishes repairing the remote target device 120, the street light technician inputs the repair result information to the dispatch and maintenance module through the device 130_3. The dispatch and maintenance module calculates the numbers of repair materials used by the street light technician and the remnants and notifies the failure report and repair module about the job completion report information. The failure report and repair module then determines whether the remote target device 120 works properly by inquiring the street light event inquiry module. If the target device 120 resumes a normal state, the error information previously recorded in the database 113 is removed. If the target device 120 still fails, the dispatch and maintenance module is notified again to repeat foregoing process until the target device 120 is repaired or foregoing process has been performed for a predetermined number of times. If the repair job is actually completed, the system responds to the user who reports the issue to inform him/her that the target device 120 has been repaired. Herein the user may be informed through a short message, an email, or a telephone call.

Besides reporting the failure of the target device 120 through the Internet, the general user may also call a street light administrator to report the issue. The general user tells the street light administrator about the position and status of the failed device over the phone, and the street light administrator then selects on an icon corresponding to the failed device in a failure report webpage and selects the failure status. Subsequently, the failure report and repair module, the dispatch and maintenance module, and the street light event inquiry module work as described above. If the repair job has been completed, the system responds to the street light administrator to inform the street light administrator that the target device 120 has been repaired, and the street light administrator then notifies the user who reported this issue. Or, the system directly informs the user who reported this issue that the target device 120 has been repaired. Herein, the user may be informed through a short message, an email, or a telephone call.

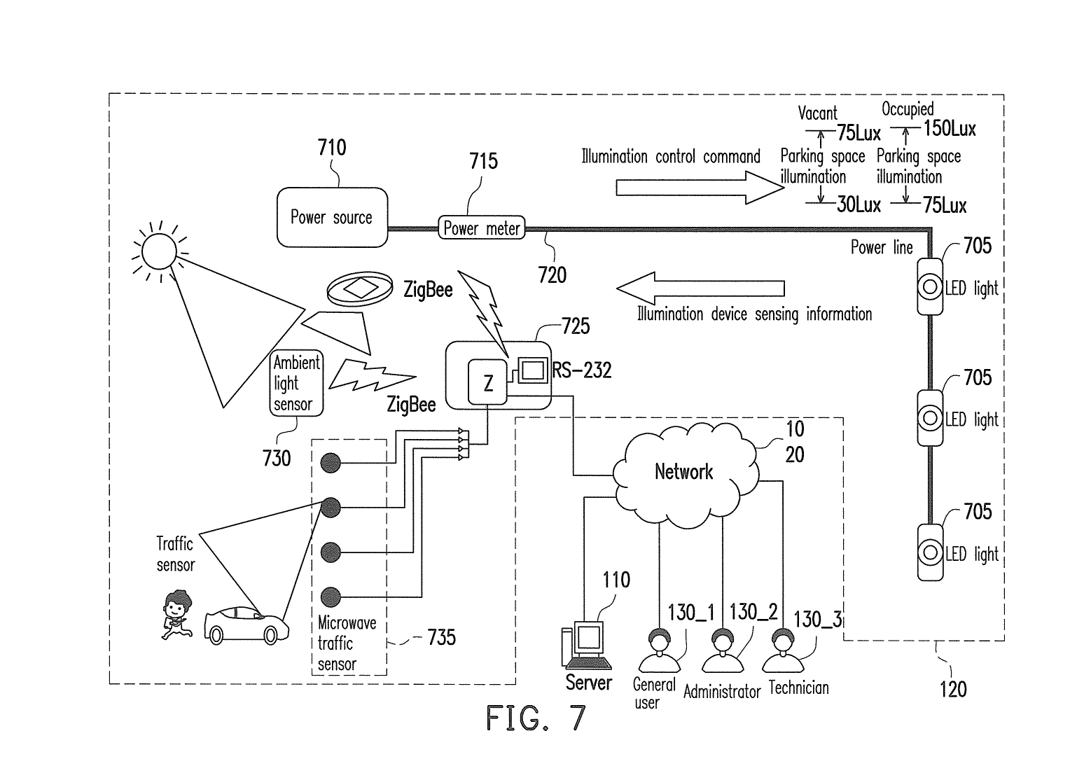

FIG. 7 is a diagram of a target device 120 applied to street light administration according to an embodiment of the disclosure. Implementation details of the present embodiment can be referred to the descriptions related to FIG. 1B to FIG. 6. Clients (i.e., the devices 130_1, 130_2, and 130_3) access the server 110 through the Internet 10 so as to monitor an illumination system (i.e., the target device 120). The server 110 controls the remote target device 120 through a network 20.

Referring to FIG. 6 and FIG. 7, the target device 120 includes a plurality of illumination devices 705 (for example, LED lights), a power source 710, a power meter 715, a gateway 725, an ambient light sensor 730, a plurality of microwave traffic sensors 735, and related facilities. The gateway 725 and the server 110 communicate with each other through an internet protocol (IP) network, such as the Internet, the 3G mobile communication protocol, or the general packet radio service (GPRS). The communication interface between the gateway 725 and each facility in the target device 120 may be a power line communication (PLC) interface, a light driving system conforming to the standard DMX-512 protocol, a digital addressable lighting interface (DALI), or a ZigBee wireless network, etc.

The illumination devices 705 are connected to a power line 720 for receiving power supplied by the power source 710. The power meter 715 is connected to the illumination devices 705 via the power line 720. The power meter 715 monitors an electrical property (for example, current, voltage, power, and/or kilowatt hour) of the illumination devices 705. The gateway 725 is connected to the server 110 through the network 10. The gateway 725 reads the electrical property of the illumination devices 705 through the ZigBee wireless network and the power meter 715 and sends the electrical property to the server 110 as a device status event of the target device 120 through the first network 10. The gateway 725 reads the value detected by the ambient light sensor 730 through the ZigBee wireless network. The gateway 725 can also read the values detected by the microwave traffic sensors 735. Thus, the gateway 725 can collect information from the power meter 715, the ambient light sensor 730, and the microwave traffic sensors 735 and send the collected information back to the server 110 as the device status event of the target device 120.

On the other hand, the gateway 725 also receives a remote device administration command from the server 110 and relays the remote device administration command to a device to be controlled. For example, the gateway 725 first sends the remote device administration command to the power meter 715 or the power source 710 through the ZigBee wireless network. Then, the power meter 715 or the power source 710 relays the remote device administration command to the illumination devices 705 through the power line 720 and the PLC mechanism. Thus, the gateway 725 can control the illumination devices 705 to adjust the illumination brightness according to the remote device administration command issued by the server 110.

A remote device administration method has been described in foregoing embodiments. The remote device administration method includes following steps. A server 110 including a database 113 and a first event notice interface 111 is provided. When a remote device administration command is about to be sent to a remote target device 120, the command content of the remote device administration command is recorded into the database 113, the command number of the remote device administration command is recorded into the first event notice interface 111. The first event notice interface 111 is checked, and the command content is sent from the database 113 to the remote target device 120 according to the first event notice interface 111.

In some embodiments, the server 110 further includes a protocol parser 115, and the remote device administration method further includes compiling the command content in the database 113 by using the protocol parser 115 and sending the compiled command content to the target device 120.

In some other embodiments, the server 110 further includes a second event notice interface 112, and the remote device administration method further includes following steps. When the remote target device 120 sends a device status event to the server 110, the device information of the device status event is recorded into the database 113, and the device information number of the device status event is recorded into the second event notice interface 112. Besides, the second event notice interface 112 is checked, and the device information is read from the database 113 according to the device information number of the second event notice interface 112.

In summary, in the embodiments described above, the command number of a remote device administration command is recorded by using a first event notice interface 111. Compared to the command content, the command number of the remote device administration command has a much lower data quantity. The server 110 can get to know whether there is any command content recorded in the database 113 by checking the first event notice interface 111. Thus, the remote device administration system 100, the server 110, and the remote device administration method described in foregoing embodiments can considerably reduce the frequency of polling, checking, or accessing the database 113 and improve the efficiency of the server 110.

The user device 130 can carry out the remote device administration method through a graphical user interface (GUI) provided by the application unit 114. For example, the application unit 114 may include a graphic information maintenance module for providing a personalized interface such that a user can monitor the remote target device 120. Herein the personalized interface refers to a convenient operation interface that is provided to the user when the user operates the target device 120 and allows the user to know where exactly the monitored target device 120 is located. In order to accomplish personalized indoor and outdoor monitoring and control, the remote device administration system 100 provides an operation interface such that a 3-dimensional (3D) operation effect can be achieved.

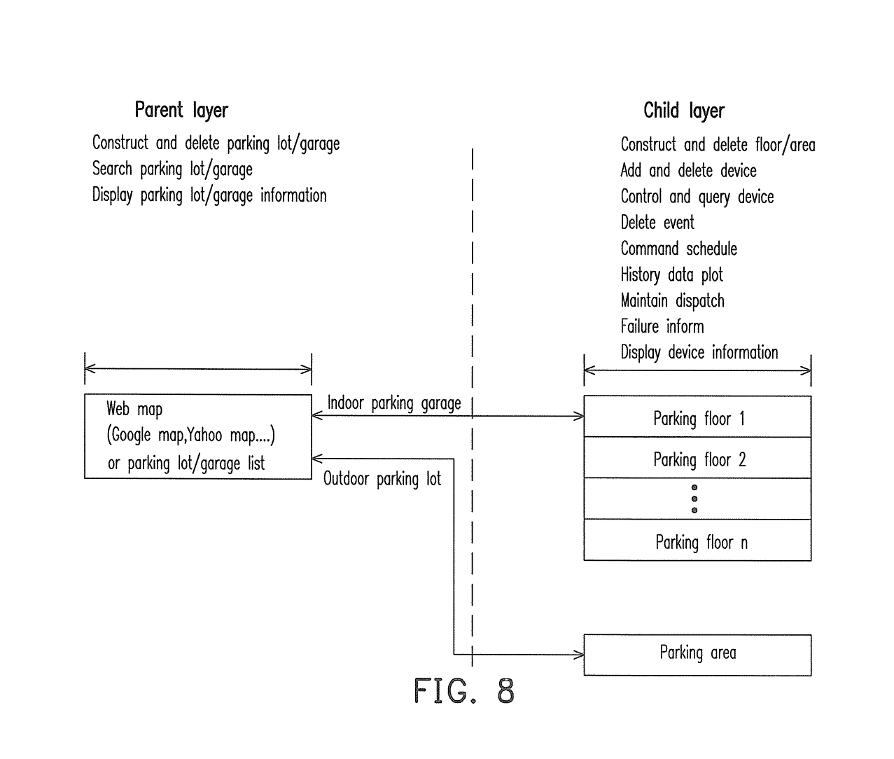

Taking an application of a remote parking garage/lot as an example, FIG. 8 is a diagram illustrating how a graphic information maintenance module operates in a 3D space according to an embodiment of the disclosure. The parent layer at the left side of FIG. 8 indicates the geographical locations of indoor/outdoor parking lots/garages, and the child layer at the right side indicates the floor plans of the parking lots/garages and the layouts of target devices 120. By selecting a parking lot/garage at the parent layer, a user can enter the child layer to monitor a target device 120 inside the parking lot/garage. An administrator can add, edit, search, delete a parking lot/garage or view parking lot/garage information on the parent layer by operating a user device 130. A general user can search or view parking lot/garage information on the parent layer by operating the user device 130.

In addition, an administrator can add, edit, and delete floor/area plan of a parking lot/garage, add, edit, control, query, and delete a target device 120 in a parking lot/garage, delete an event, schedule commands, plot history data, maintain dispatch, inform failure, or view information of a target device 120 on the child layer by operating the user device 130. A general user can view information of target devices 120 on each floor of a parking lot/garage or inform a failure on the child layer by operating the user device 130.

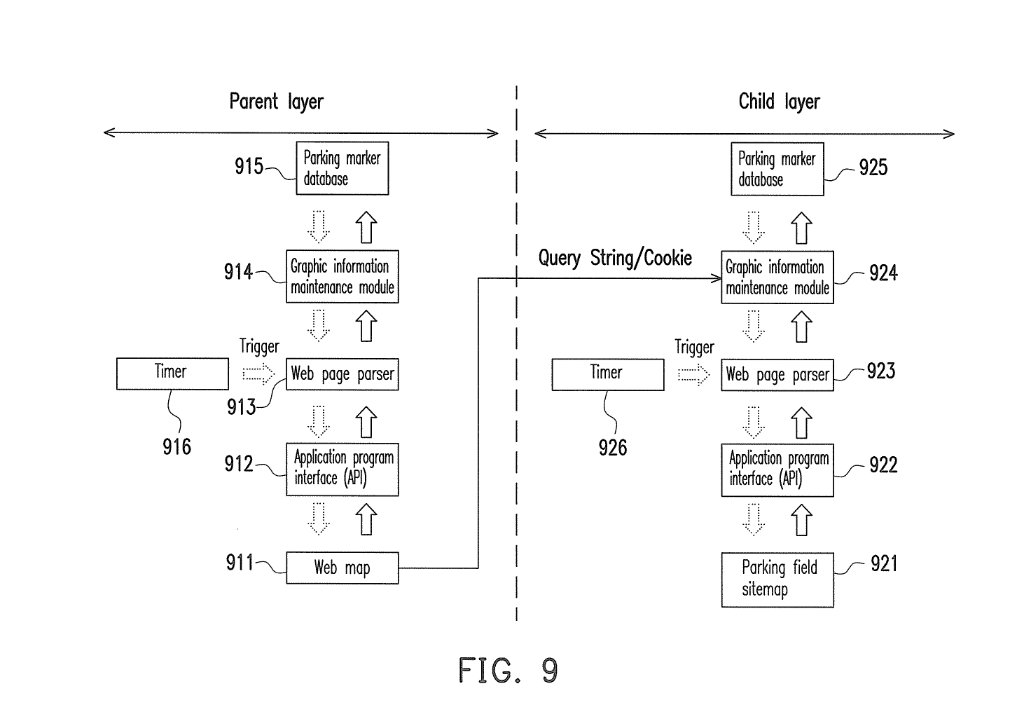

FIG. 9 is a diagram illustrating functional modules of the application unit 114 according to an embodiment of the disclosure. In order to achieve aforementioned functions, the application unit 114 is designed to have graphical information modules as shown in FIG. 9, wherein the parent layer at the left side and the child layer at the right side are respectively an independent geographic information system (GIS). The parent layer includes a web map 911, an application program interface (API) 912, a web page parser 913, a graphic information maintenance module 914, and a parking marker database 915. The child layer includes a parking field sitemap 921, an API 922, a web page parser 923, a graphic information maintenance module 924, and a parking field sitemap database 925. The web page parsers 913 and 923 may be implemented with JavaScript or VBScript, and the databases 915 and 925 may be implemented with Access, SQL, MySQL, or XML.

The web map 911 is an online GIS web map, such as Google Map or Yahoo map, and markers of indoor/outdoor parking lots/garages are placed on the web map 911. The parent layer shows a user of the user device 130 the location of a monitored parking lot/garage and real-time system monitoring status. When the marker of the parking lot/garage is selected, the parent layer displays general information of the child layer to activate the child layer and display the parking field sitemap 921. Herein the general information may be the basic information, location, company, and/or device status (for example, a normal status or a failed status) of the parking lot/garage. Namely, the marker of a parking lot/garage in the web map 911 can display basic information and real-time system monitoring status of the parking lot/garage. The dotted arrows in the parent layer indicate how the web map 911 displays the marker of a parking lot/garage. For example, after the web map 911 accesses the database 915 in the eXtensible Markup Language (XML) format through an application program, the web page parser 913 captures the coordinates of each parking lot/garage from the database 915 in the XML format. The captured parking lot/garage coordinates may be in different formats, such as WGS 84 datum or WGS 84 DMS. Thereafter, the coordinate data of the parking lot/garage is sent to the API 912 provided by the web map 911 to establish the marker of the parking lot/garage in the web map 911. Similarly, after the web page parser 913 captures information of each parking lot/garage and the real-time system monitoring status of the current parking lot/garage from the database 915, information to be displayed on the marker is constructed through the API 912 of the web map 911. A timer 916 is disposed to notify the web page parser 913 that a predetermined update time is reached. At this predetermined update time, the real-time system monitoring status of the parking lot/garage is captured again and the information displayed on the marker is updated, so that a dynamic display effect can be achieved.

The solid arrows in the parent layer indicate a procedure for constructing and updating parking lot/garage information. For example, after a user determines the location of a parking lot/garage in the web map 911 through the user device 130, the user can specify a position in the web map 911 through the API 912 of the web map 911 to obtain the coordinates of the specified position and construct the marker. The web page parser 913 sends the coordinate information to the application program as a web service, so as to write the coordinate information into the parking lot/garage database 915 in the XML format. The user device 130 may also edit or update the information displayed on a marker through the same procedure.

Referring to the child layer portion at the right side of FIG. 9, the parking field sitemap 921 is another GIS map. When a user selects at the marker of a parking log in the web map 911 by using the user device 130, a button or hyperlink is displayed to let the user to select whether to enter the parking lot/garage. Foregoing “selecting” operation of the user may include clicking, double clicking, or any other option selecting action. Or, the “selecting” operation of the user may also be an action of moving the cursor on the marker/icon of a parking lot/garage without clicking to display the basic information (for example, a button or a hyperlink).

When a user selects at the button or hyperlink through the user device 130, the web page of the parent layer issues a query string (e.g. QueryString) or a cookie for identifying a parking lot/garage to the child layer to activate the child layer and display (redirect to) the web page of the parking field sitemap 921. After the parking field sitemap 921 at the child layer receives the query string or the cookie from the web map 911, an application program at the child layer obtains the floor plan of the corresponding parking lot/garage, the coordinates of a target device 120 in the floor plan, and status information of the target device 120 from the parking field sitemap database 925 and then sends aforementioned information to the API 922 at the front end. The API 922 displays the marker and marker information corresponding to the target device 120 on the floor plan according to the coordinates of the target device 120 in the floor plan.

The target device 120 may be an illumination device (for example, LED lights 705), a power meter 715, a photo sensor 730, a temperature sensor, or a gateway 725. For example, the gateway 725 reads an electrical property of the LED lights 705 through the power meter 715 and sends the electrical property to the API 922 at the child layer as a device status event of the target device 120. The API 922 displays the device status event on the marker corresponding to the target device 120 as display information on the marker. The timer 926 is disposed to notify the web page parser 923 that a predetermined update time is reached. At this predetermined update time, the real-time monitoring and control status of the target device 120 (for example, the electrical property or operation status of the target device 120) is captured again and the display information on the marker is updated so as to achieve a dynamic display effect. The user can select different floor in the web page of the parking field sitemap 921 and monitors and controls target devices 120 on current floor in real time through the user device 130

The solid arrows in the child layer indicates how a user constructs, adds, and changes a floor plan and adds, edits, and controls a target device 120 by using the user device 130. After the user dynamically adds and uploads a floor plan, a backend application program stores the title and storage path of the floor plan and the code of the corresponding parking lot/garage into the backend parking field sitemap database 925 for subsequent access. After determining the position of the target device 120 in the floor plan, the user can select at a position in the floor plan through the API 922 of the parking field sitemap 921 to obtain the coordinates of the selected position and construct the marker of the target device 120. The icon of the marker may be determined according to the type of the device. The user can select a desired icon according to the type of the target device 120. After the user selects the icon and fills in information related to the device through the user device 130, the application program associates the coordinates of the marker, the device information, and the code of the corresponding parking lot/garage with the floor number and writes foregoing information into the parking field sitemap database 925 for subsequent access. The user can select on the marker of the target device 120 in the web page of the parking field sitemap 921 through the user device 130 to issue a control command (i.e., a remote device administration command) to the corresponding target device 120 (for example, to adjust the intensity of the LED lights 705, turn on/off the LED lights 705, or schedule different devices). After the remote device administration command is issued, the application program associates the device information with the control command and writes foregoing information into the database 925. Later on, the protocol parser 115 obtains the remote device administration command and sends it to the target device 120 of the parking lot/garage.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A remote device administration system, comprising:
a target device; and
a server, coupled to the target device, comprising a database and a first event notice interface, wherein a command content of a remote device administration command is recorded in the database, a command number of the remote device administration command is recorded in the first event notice interface, and the server sends the command content from the database to the target device according to the command number of the first event notice interface.

2. The remote device administration system according to claim 1, wherein the server further comprises a protocol parser, and the protocol parser compiles the command content in the database and sends the compiled command content to the target device.

3. The remote device administration system according to claim 1, wherein the server further comprises a second event notice interface, the target device has a device status event, a device information of the device status event is recorded in the database, a device information number of the device status event is recorded in the second event notice interface, and the server reads the device information from the database according to the device information number of the second event notice interface.

4. The remote device administration system according to claim 3, wherein the server further comprises a protocol parser, and the protocol parser decompiles the device status event and sends the device information to the database.

5. The remote device administration system according to claim 1, wherein the target device comprises:
an illumination device, connected to a power line;
a power meter, connected to the illumination device through the power line, for monitoring an electrical property of the illumination device; and
a gateway, connected to the server through a first network, for reading the electrical property of the illumination device through the power meter and sending the electrical property to the server as a device status event of the target device through the first network.

6. The remote device administration system according to claim 1 further comprising:
a user device, for sending the remote device administration command to the server through a second network.

7. A remote device administration server, comprising:
an application unit;
a database, coupled to the application unit;
a first event notice interface, coupled to the application unit, wherein the application unit records a command content of a remote device administration command into the database and records a command number of the remote device administration command into the first event notice interface; and
a protocol parser, coupled to the database and the first event notice interface, for reading the command content of the remote device administration command from the database according to the command number of the first event notice interface and compiling the command content of the remote device administration command.

8. The remote device administration server according to claim 7 further comprising:
a second event notice interface, coupled between the application unit and the protocol parser, wherein and the protocol parser records a device information of a device status event from a target device into the database and records a device information number of the device status event into the second event notice interface;
wherein the application unit reads the device information from the database according to the device information number of the second event notice interface.

9. The remote device administration server according to claim 7, wherein the protocol parser is connected to a target device through a first network.

10. The remote device administration server according to claim 7, wherein the application unit receives the remote device administration command issued by a user device through a second network.

11. A remote device administration method, comprising:
providing a server, wherein the server comprises a database and a first event notice interface;
recording a command content of a remote device administration command into the database, and recording a command number of the remote device administration command into the first event notice interface; and
checking the first event notice interface, and sending the command content from the database to a remote target device according to the command number of the first event notice interface.

12. The remote device administration method according to claim 11, wherein the server further comprises a protocol parser, and the remote device administration method further comprises:
compiling the command content in the database and sending the compiled command content to the target device by using the protocol parser.

13. The remote device administration method according to claim 11, wherein the server further comprises a second event notice interface, and the remote device administration method further comprises:
issuing a device status event by using the remote target device, recording a device information of the device status event into the database, and recording a device information number of the device status event into the second event notice interface; and
reading the device information from the database according to the device information number of the second event notice interface.

14. The remote device administration method according to claim 13, wherein the server further comprises a protocol parser, and the remote device administration method further comprises:
decompiling the device status event and sending the device information to the database by using the protocol parser.

15. A remote parking lot administration system, comprising a user interface, wherein the user interface further comprises:
a parent layer, having at least one web map, wherein the at least one web map contains a marker of at least one parking lot; and
a child layer, having at least one parking field sitemap, wherein the at least one parking field sitemap contains a marker of at least one target device,
wherein when the marker of the at least one parking lot is selected, the parent layer displays a general information of the child layer to activate the child layer and display the parking field sitemap.

16. The remote parking lot administration system according to claim 15, wherein the target device comprises:
an illumination device, connected to a power line;
a power meter, connected to the illumination device through the power line, for monitoring an electrical property of the illumination device; and
a gateway, for reading the electrical property of the illumination device through the power meter and sending the electrical property to the child layer as a device status event of the target device, wherein the child layer displays the device status event on the marker of the target device.

17. The remote parking lot administration system according to claim 15, wherein the parent layer further comprises:
an application program interface (API), for allowing a user to select the web map and obtaining a coordinate of a selected position, and for constructing the marker of the parking lot at the selected position;
a database; and
a web page parser, for recording the coordinate into the database.

18. The remote parking lot administration system according to claim 15, wherein the child layer further comprises:
a database, having a floor plan of the parking lot; and
an application program interface (API), for obtaining the floor plan from the database according to the parent layer and displaying the floor plan in the parking field sitemap.

19. The remote parking lot administration system according to claim 18, wherein the application program interface (API) obtain the floor plan of the parking lot from the database according to a corresponding query string or a corresponding cookie sent from the parent layer.

20. The remote parking lot administration system according to claim 15, wherein when the marker of the parking lot is selected, the parent layer sends a corresponding query string or a corresponding cookie to the child layer to activate the child layer for displaying the parking field sitemap.

21. The remote parking lot administration system according to claim 15, wherein the general information contains a basic information, a location, a company, and/or a device status of the parking lot.

22. The remote parking lot administration system according to claim 15, wherein a remote device administration command is sent to the target device of the parking lot by selecting the marker of the target device.
